(19) United States
(12) Patent Application Publication
(10) Pub. No.: US 2010/0269084 A1
(43) Pub. Date: Oct. 21, 2010

(54) Visibility and Transport Kernels for Variable Etch Bias Modeling of Optical Lithography

(76) Inventor: Yuri Granik, Palo Alto, CA (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/625,538

(22) Filed: Nov. 24, 2009

Related U.S. Application Data
(60) Provisional application No. 61/117,283, filed on Nov. 24, 2008.

(51) Int. Cl. G06F 17/50

(52) U.S. Cl. 716/20

(57) ABSTRACT

Kernels that model characteristics of the etching portion of an optical lithographic model are provided. In various implementations, a visibility density kernel is provided. The visibility density kernel approximates the area of the simulated substrate that is “visible” to the etchant. With various implementations, a transport kernel is provided. The transport kernel approximates the convective “movement” of etchant.

### RELATED APPLICATIONS

This application claims priority under 35 U.S.C. §119(e) to U.S. Provisional Patent Application No. 61/117,283 entitled “Variable Etch Bias Transport Kernels,” filed on Nov. 24, 2008, and naming Yuri Granik as inventor, which application is incorporated entirely herein by reference.

### FIELD OF THE INVENTION

The invention relates to the field of integrated circuit design and manufacturing. More particularly, various implementations of the invention are applicable to modeling various effects of an optical lithographic process.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (IC's).

Several steps are common to most design flows. Initially, a design may start at a high level of abstraction, by a designer creating a specification that describes particular desired functionality. This specification, typically implemented by a programming language, such as the C or C++ programming language for example, describes at a high level the desired behavior of the device. Designers will then often take this specification for the design and create a logical design, often implemented in a netlist, through a synthesis process. The logical design is often referred to as a “register transfer level” (RTL) description or register transfer level design.

A register transfer level design is often implemented by a hardware description language (HDL) such as Verilog, SystemVerilog, or Very High speed hardware description language (VHDL), and describes the operation of the device by defining the flow of signals or the transfer of data between various hardware components within the design. More particularly, a register transfer level design describes the interconnection and exchange of signals between hardware registers and the logical operations that are performed on those signals.

The design process includes another transformation, this time the register transfer level design is transformed into a gate level design. Gate level designs describe the actual physical components such as transistors, capacitors, and resistors as well as the interconnections between these physical components. Often, gate level designs are also implemented by a netlist, such as a mapped netlist. Lastly, the gate-level design is taken and another transformation is carried out. First by place and route tools that arrange the components described by the gate-level netlist and route connections between the arranged components; and second, by layout tools that generate a layout description having layout “shapes” or “patterns” that may then used to fabricate the electronic device, through for example, an optical lithographic process.

Integrated circuit layout descriptions can be provided in many different formats. The Graphic Data System II (GDSII) format is popular for transferring and archiving two-dimensional graphical IC layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in integrated circuit layout designs that are employed to manufacture integrated circuits. Once the microcircuit device design is finalized, the layout portion of the design can be used by fabrication tools to manufacturer the device using a photolithographic process.

There are many variations of the fabrication processes used to manufacture a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in layout design data define the relative locations or areas of the circuit device that will be exposed to radiation through the mask. A mask or reticle writing tool is used to create the mask based upon the layout design data, after which the mask can be used in a photolithographic process.

As designers and manufacturers continue to increase the number of circuit components in a given area and/or shrink the size of circuit components, the shapes reproduced on the substrate become smaller and are placed closer together. This reduction in feature size increases the difficulty of faithfully reproducing the image intended by the layout design onto the substrate. Various common techniques exist for increasing the fidelity of the optical lithographic process. For example, optical process correction (OPC), phase shift masks (PSM) or other resolution enhancement techniques (RET) are commonly employed to prepare a physical layout designs for manufacturing.

These various resolution enhancement techniques are commonly applied at different stages of device development. Many of these techniques make adjustments to the layout design, or the mask, based upon simulations of the optical lithographic process. More particularly, the mask is typically adjusted in such a manner that a simulation of the printed layout based upon the adjusted mask more closely resembles the intended layout. Accordingly, accurate functions that model or predict the lithographic process are needed.

### SUMMARY OF THE INVENTION

The present invention provides methods of modeling an optical lithographic process. In various implementations, kernels that models characteristics of the etching portion of the optical lithographic model are provided. In various implementations, a visibility density kernel is provided. The visibility density kernel approximates the area of the simulated substrate that is “visible” to the etchant. With various implementations, a transport kernel is provided. The transport kernel approximates the convective “movement” of etchant.

### BRIEF DESCRIPTION OF THE DRAWINGS

The present invention will be described by way of illustrative embodiments shown in the accompanying drawings in which like references denote similar elements, and in which:

FIG. 1 shows an illustrative computing environment;

FIG. 2 illustrates a mask feature and corresponding printed layout pattern;

FIG. 3 illustrates the mask feature of FIG. 2, having an edge fragmented;

FIG. 4A illustrates the mask feature of FIG. 2, having the edges fragmented and adjusted and corresponding printed layout pattern;

FIG. 4B illustrates a modified mask feature corresponding to the mask feature of FIG. 4B;

FIG. 5 illustrates a simulated resist contour and corresponding simulated etched contour;

FIG. 6 illustrates a method of modeling an optical lithographic etching process;

FIG. 7 illustrates a layout pattern and corresponding resist grid;

FIG. 8 illustrates a simulated resist contour; and

FIG. 9 illustrates a simulated resist contour and corresponding simulated etched contour.

### DETAILED DESCRIPTION OF ILLUSTRATIVE IMPLEMENTATIONS

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “determine” to describe the disclosed methods. Such terms are often high-level abstractions of the actual operations that are performed. The actual operations that correspond to these terms will often vary depending on the particular implementation, and will be readily discernible by one of ordinary skill in the art.

Furthermore, in various implementations of the invention, a mathematical function may be employed to approximate a real world process. With some implementations, functions describing an optical lithographic process, or portion of an optical lithographic process is employed. Those of skill in the art will appreciate that these functions represent real world physical processes. Accordingly, simulations based upon these functions are a representation of the tangible results, should the process be carried out under the simulated conditions.

Some of the methods described herein can be implemented by software stored on a computer readable storage medium, or executed on a computer. Accordingly, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art may be omitted.

### Illustrative Computing Environment

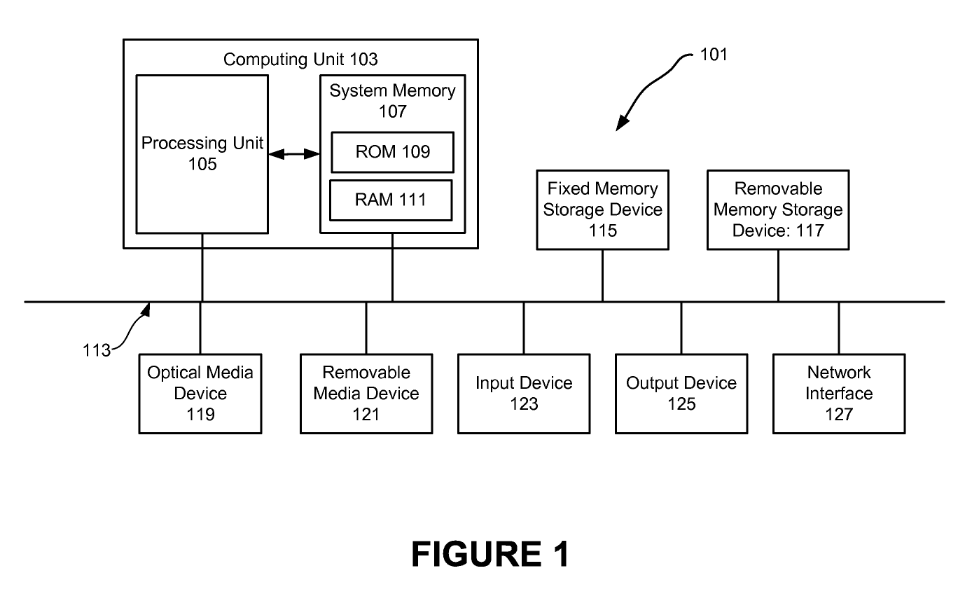

As the techniques of the present invention may be implemented using software instructions, the components and operation of a generic programmable computer system on which various implementations of the invention may be employed is described. Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as; a fixed memory storage device 115, for example, a magnetic disk drive; a removable memory storage device 117, for example, a removable solid state disk drive; an optical media device 119, for example, a digital video disk drive; or a removable media device 121, for example, a removable floppy drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

### Illustrative Resolution Enhancement Process

In a photolithographic process, as explained above, electromagnetic radiation is transmitted through selectively transparent areas of a mask. The radiation passing through these transparent areas then irradiates desired portions of a photoresistive material on a layer of semiconductor substrate. The mask in turn is created from layout design data describing the geometric features that should be manufactured on the semiconductor substrate, by way of the photolithographic process, in order to create the desired circuit. For example, if a transistor should have a rectangular gate region, then the layout design data will include a rectangle defining that gate region. This rectangle in the layout design data is then implemented in a mask for “printing” the rectangular gate region onto the substrate.

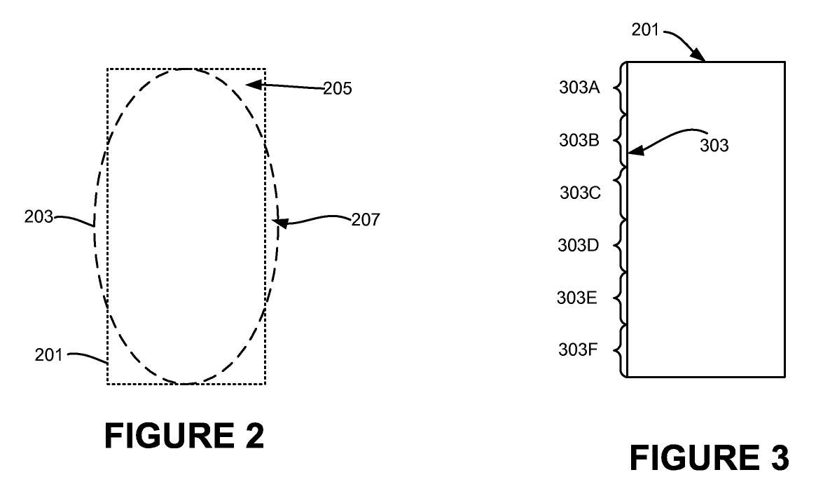

Additionally, as discussed modern integrated circuit design and manufacturing flows typically include various layout design adjustment steps, occasionally referred to as pattern correction steps. In order to more fully understand the corner approximation techniques discussed herein, an illustrative shape based correction process is discussed. As stated, an optical lithographic process seeking to reproduce the rectangular mask feature 201 illustrated in FIG. 2, may only produce the image 203. As seen in this figure, the image 203 is substantially narrower in the corners (e.g., corner 205) than the ideal rectangular shape intended by the mask feature 201. Likewise, the image 203 may have areas (e.g., 207) that extend beyond the ideal rectangular shape intended by the mask feature 201. The intended shape or feature often is referred to as the target shape, or the target image. The image created by employing the mask in a photolithographic process (i.e the image 203) as stated above, may be referred to as the printed image.

To correct for these optical distortions, many circuit designers will attempt to modify the layout design data, producing modified mask features, to enhance the resolution of the images that will be produced by the modified mask during the photolithographic process. One resolution enhancement technique often employed by designers is called optical process correction (OPC) or optical proximity correction. In a typical optical proximity correction process, the edges of the geometric elements in the design are fragmented and adjusted in such a manner as to produce a printed image that more closely resembles the target image.

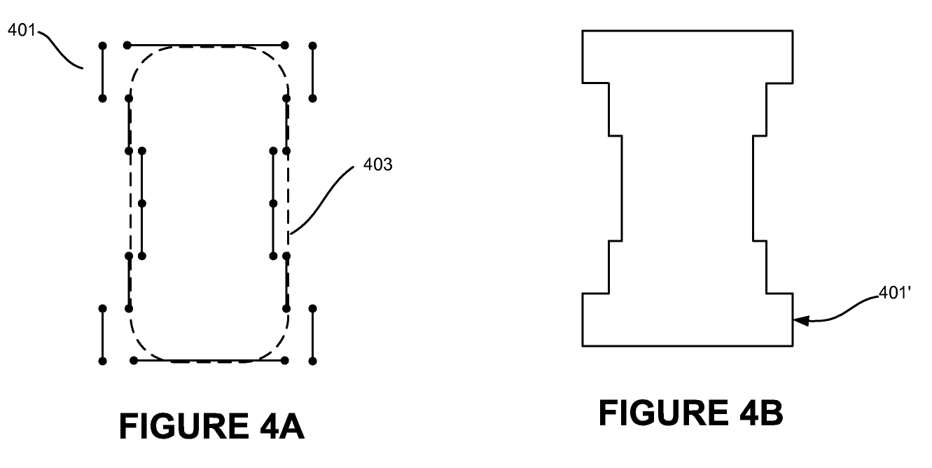

FIG. 3 illustrates the mask shape 201 of FIG. 2, having an edge 303 thereof fragmented into edge fragments (often referred to as edge segments) 303A-303F. During resolution enhancement, the edge fragments 303A-303F, along with any other edge fragments generated may be moved such that a simulated printed image based upon the positioning of the moved edge fragments more closely resembles the intended image. For example, the mask shape 201 may be fragmented and modified to produce the fragmented mask shape 401 shown in FIG. 4A. As can be seen from this figure, a simulated printed image 403 based upon the modified mask shape 401 more closely resembles the mask shape 201 (i.e. the intended image) of FIG. 2 than the simulated printed image 203 does. Once the final position of the edge fragments is determined, as shown in FIG. 4A, a modified mask feature can be created from the corrected layout design data. FIG. 4B shows a modified mask feature 401′, produced from the displaced edge fragments of FIG. 4A.

### Optical Lithography Simulation

As indicated, resolution enhancement techniques are iterative in nature. More specifically, a printed image is simulated, the printed image is then compared to the target image, and the mask features are fragmented and adjusted based upon the comparison between the simulated image and the target image. Subsequent iterations of simulation, compare, and adjust are performed until the simulated image sufficiently matches the target image. Accordingly, accurate methods of simulating an image printed through an optical lithographic process are needed.

Various functions to approximate an optical lithographic process are used. For example, the VTR model is described in detail in U.S. Pat. No. 6,643,616, entitled “Integrated Device Structure Prediction Based On Model Curvature,” filed Nov. 4, 2003, and naming Yuri Granik et al. as inventors, which patent is incorporated entirely herein by reference. Additionally, lithographic modeling based upon the Hopkins Equation is discussed in detail in Process Variation Aware OPC with Variation Lithography Modeling, by Peng Yu et al., Proceeding of the 43^{rd} Annual Conference on Design Automation, 24-28 Jul. 2006, which article is incorporated entirely herein by reference. Often, modern lithographic models utilize kernels to approximate the various components or “effects” of the optical lithographic process.

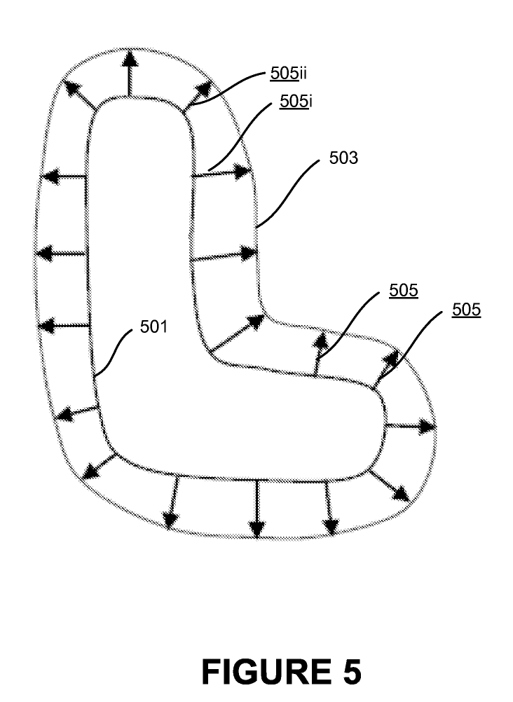

Conventional simulators typically include a separate kernel that models the resist and etch component of optical lithography. One such technique incorporates a Variable Etch Bias (VEB) kernel. Variable etch bias kernels are discussed in greater detail in Correction for Etch Proximity: New Models and Applications, by Yuri Granik, Proceeding of SPIE Vol. 4346 (2001), which article is incorporated entirely herein by reference. Variable etch bias kernels bias vertices of a simulated resist contour. Typically, the bias is positive for the outward direction of the polygon. More particularly, FIG. 5 illustrates a simulated resist contour 501, and corresponding simulated etched contour 503. As indicated by the biasing arrows 505, the simulated etched contour has been “biased” in an outward direction away from the simulated resist contour 501. Typically, dense simulations based upon a CM1 or a VT5 resist model are used as inputs to a variable etch bias model. The bias values b often vary along the perimeter of a polygon. For example, the bias value b 505i is noticeably larger than the bias value 505ii shown in FIG. 5.

### Visibility and Transport Kernels for Variable Etch Bias Simulations

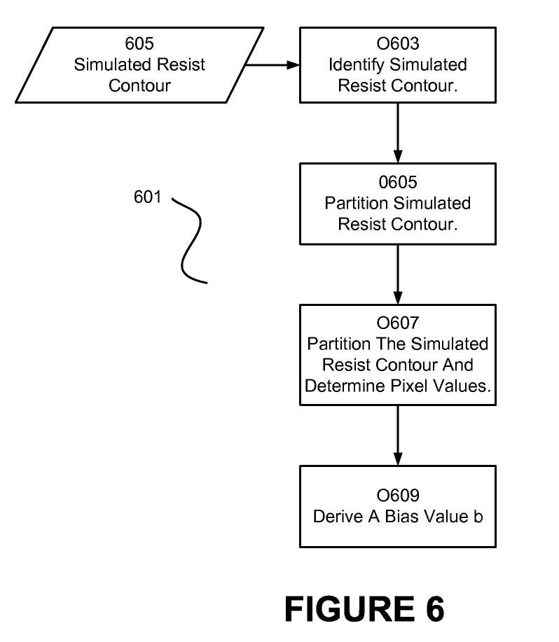

FIG. 6 illustrates a method 601 that may be provided by various implementations of the present invention to simulate an etched contour based upon a variable etch bias model. As can be seen from this figure, the method 601 includes an operation 603 for receiving a simulated resist contour. Often, contours are referred to as patterns, shapes, or polygons. These terms are used interchangeably in the art as well as herein. Any precise meaning attached to a particular term will be apparent form the context.

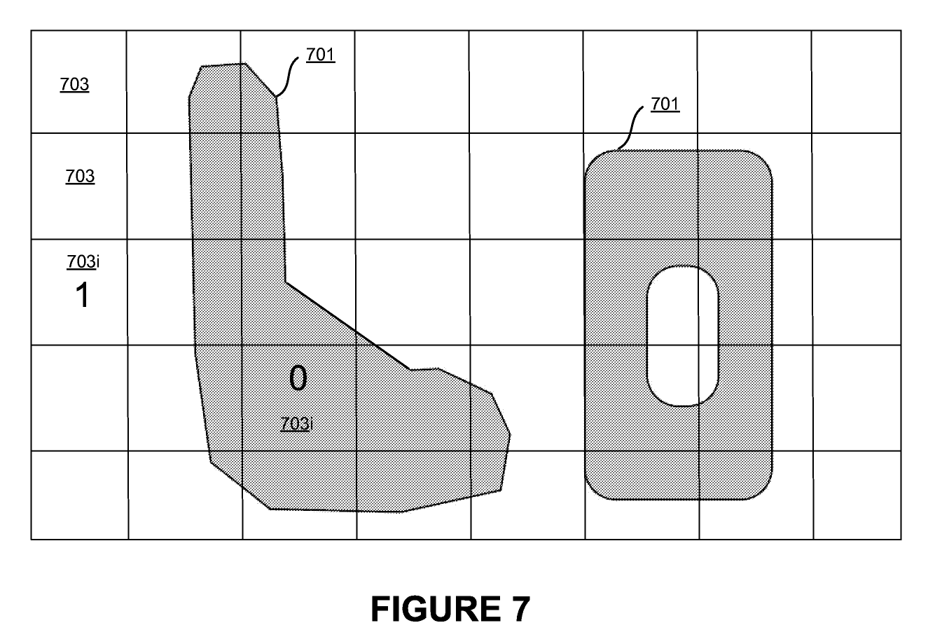

The method 601 further includes an operation 607 for partitioning the simulated resist contour 505 and determining pixel values. In various implementations, the pixel values are 1 outside the polygons and 0 inside the polygons. For example, FIG. 7 illustrates simulated resist contours 701. As can be seen from this figure, the layout has been partitioned, and each pixel 703 of the partition may be assigned a value based upon the location of the simulated contours 701. More particularly, as illustrated, the pixel 703i has a value of 1 as the pixels 703i is located outside a polygon, while the pixel 703ii has a value of 0 as the pixel 703ii is located inside a polygon.

Returning to FIG. 6, the method 601 further includes an operation 609 for deriving a biasing b. In various implementations of the invention, the bias b is given by the Equation (1) where x and y are the layout coordinates, s is the diffusion length, u is the kernel shift, and c is a constant.

$$b = {c}_{0} + {\sum }_{i = 1}^{M} {c}_{i} {D}_{i} ( {s}_{i} , {u}_{i} , x , y ) \qquad ( 1 )$$

As can be seen from this equation, the bias b is a linear combination as densities M. In various implementations of the invention, M equals 2. With alternative implementations, M equals 4. As used herein, the models or functions used to derive the individual densities may themselves be referred to as kernels.

### External Visibility Density

With various implementations of the invention, a one of the densities M is an external visibility density, often referred to as a direct visibility density. The direct visibility density is determined by the area that is “directly visible” from a point of interest (POI). More particularly, if one were to “look” in the direction perpendicular to the polygon edge to which the point of interest belongs, as far as the diffusion length s. With some implementations, the kernel shift u is used as an offset from the resist contour, such that the point of interest can be positioned in the opening between polygons.

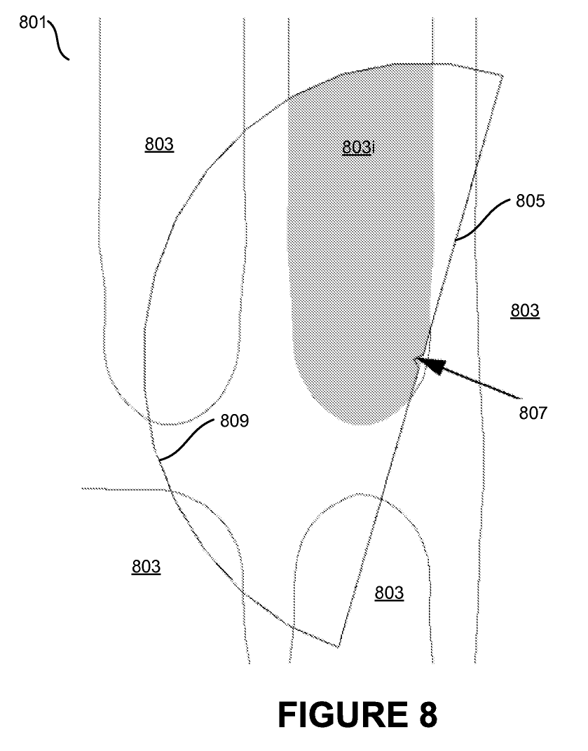

FIG. 8 illustrates a simulated resist contour 801, having polygons 803. As can be seen from this figure, the direct visibility density may be visualized as the area bounded by a line (i.e. the line 805) running tangent to the point of interest and the polygon edge (i.e. the point 807) and a semicircle (i.e. the semi-circle 809) of radius The direct visibility density may be derived as the “visible” portion of the bounded area illustrated in FIG. 8 by the following equation, where V is the area of direct visibility from the point of interest:

$$D ( s , u ; x , y ) = \{ \begin{matrix}\frac{V ( x , y )}{0.5 π {s}^{2}} < 0 {\vert}_{u \geq 0} \\ \frac{V ( x , y )}{0.5 π {s}^{2}} \geq 0 {\vert}_{u < 0}\end{matrix} \qquad ( 2 )$$

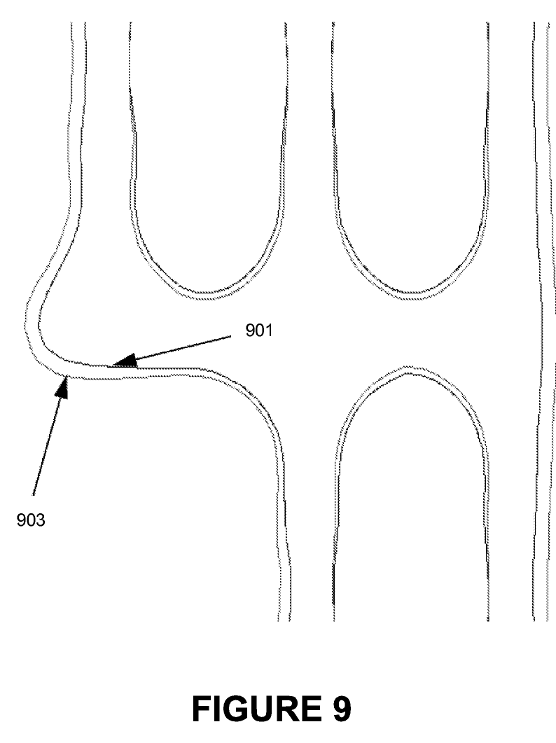

As defined in Equation (2), the direct visibility densities are always positive for kernel shifts u greater than zero. In various implementations, the density values are scaled between zero and one. Accordingly, if “nothing is visible” form the point of interest, then the direct visibility density is zero. The direct visibility density characterizes a separation between layout features. This concept is further illustrated in FIG. 9, where bias b has been derived proportional to the direct visibility density.

As can be seen form this figure, a simulated resist contour 901 and a simulated etched contour 903, derived based upon the simulated resist contour 901 are shown. As evident, the bias b is greater in “open” areas (i.e. areas where there is more “visibility”).

### Internal Visibility Density

In various implementations of the invention, a one of the densities M is an internal visibility density. The internal visibility density may be derived in a similar manner as to the direct visibility density. The main difference is that with derivation of the internal visibility density, the kernel is looking inward into the interior of the polygon as opposed to looking outward for the external kernel. As a result, the point of interest is located inside the polygon if the kernel shift u is positive, as illustrated by Equation (3) shown below.

$$D ( s , u ; x , y ) = \{ \begin{matrix}\frac{V ( x , y )}{0.5 π {s}^{2}} < 0 {\vert}_{u < 0} \\ \frac{V ( x , y )}{0.5 π {s}^{2}} \geq 0 {\vert}_{u \geq 0}\end{matrix} \qquad ( 3 )$$

With some implementations, the internal visibility density may also be bound or scaled between zero and one.

### Transport Density

The transport density describes convective transportation of etching materials form open space or from the interior of a polygon if the kernel shift u is negative, with the transport rate being dependant upon the pattern density. The transport density has a variable shift linearly depends upon another density. A similar effect is captured by a shifted convolution density, but without the density-dependant convention rate. The shifting operator of the transport density depends on the secondary Gaussian density S(t) having a diffusion length t, which may be represented by:

S(t;x,y)=G(t;x,y) [symbol] R(x,y) (4)

The density may be derived at the point of interest (x, y). The length v of the transport shift vector is variable as represented in the following equation, where u is a constant, c is the secondary density multiplier, and t is the secondary density diffusion length:

v(x,y)=u+cS(t;x,y) (4)

The final value of the transport density may be derived based upon the shifted density by applying the shifting operator U to the primary density D(s;x,y), as shown below:

U(v(u,c,t))D(s;x,y)=D(s;x−vₓ,y−v_{y})=D(s,u,c,t;x,y) (6)

Accordingly, the transport density depends upon the primary diffusion length s, the constant part of the kernel shift u, the secondary density multiplier c, and the secondary diffusion length t.

### CONCLUSION

As described above, methods of modeling an optical lithographic process, including modeling the characteristics of the etching portion of the optical lithographic model are provided. In various implementations, a visibility density kernel is provided. The visibility density kernel approximates the area of the simulated substrate that is “visible” to the etchant. With various implementations, a transport kernel is provided. The transport kernel approximates the convective “movement” of etchant.

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A computer-implemented method for simulating an optical lithographic process comprising
receiving at least a portion of a layout pattern to be printed on a substrate through an optical lithographic process;
identifying a resist function that approximates at least the resist component of the optical lithographic process by relating an intended image to a simulated resist image;
identifying an etch function that approximates the etch component of the optical lithographic process by relating a simulated resist image to a simulated etched image, the etch function having a transport kernel and a visibility kernel;
deriving on a computer a simulated resist pattern by solving the resist function for the portion of the layout pattern; and
deriving on the computer a simulated etched pattern by solving the etch function for the simulated resist pattern.

2. The computer-implemented method recited in claim 1, further comprising saving the simulated etched pattern onto one or more tangible memory storage media.

3. The computer-implemented method recited in claim 2, the visibility kernel comprising a visibility density component.

4. The computer-implemented method recited in claim 3, the visibility density component being a direct visibility density component.

5. The computer-implemented method recited in claim 4, wherein:
the portion of the layout pattern is partitioned into a grid having coordinates x and y;
the portion of the layout pattern has a polygon V;
the etchant has a diffusion length s;
the direct visibility density component D for a given edge offset u is derived from the following equation:
$$D ( s , u ; x , y ) = \{ \begin{matrix}\frac{V ( x , y )}{0.5 π {s}^{2}} < 0 {\vert}_{u \geq 0} \\ \frac{V ( x , y )}{0.5 π {s}^{2}} \geq 0 {\vert}_{u < 0}\end{matrix} .$$

6. The computer-implemented method recited in claim 5, wherein:
the resist function includes a secondary Gaussian density derivation; and
the transport kernel is based in part upon a shifted convolution of the secondary Gaussian density derivation.

7. The computer-implemented method recited in claim 3, the visibility density component being an internal visibility density component.

8. The computer-implemented method recited in claim 7, wherein:
the portion of the layout pattern is partitioned into a grid having coordinates x and y;
the portion of the layout pattern has a polygon V;
the etchant has a diffusion length s;
the internal visibility density component D for a given edge offset u is derived from the following equation:
$$D ( s , u ; x , y ) = \{ \begin{matrix}\frac{V ( x , y )}{0.5 π {s}^{2}} \geq 0 {\vert}_{u \geq 0} \\ \frac{V ( x , y )}{0.5 π {s}^{2}} < 0 {\vert}_{u < 0}\end{matrix} .$$

9. A computer-implemented method for simulating an optical lithographic etching process comprising
receiving at least a portion of a simulated resist pattern;
identifying an etch function that approximates an optical lithographic etching process by relating a simulated resist image to a simulated etched image, the etch function having a transport kernel and a visibility kernel; and
deriving on the computer a simulated etched pattern by solving the etch function for the portion of the simulated resist pattern.

10. The computer-implemented method recited in claim 9, further comprising saving the simulated etched pattern onto one or more tangible memory storage media.

11. The computer-implemented method recited in claim 10, the visibility kernel comprising a visibility density component.

12. The computer-implemented method recited in claim 11, the visibility density component being a direct visibility density component.

13. The computer-implemented method recited in claim 12, wherein:
the portion of the simulated resist pattern is partitioned into a grid having coordinates x and y;
the portion of the simulated resist pattern has a polygon V;
the etchant has a diffusion length s;
the direct visibility density component D for a given edge offset u is derived from the following equation:
$$D ( s , u ; x , y ) = \{ \begin{matrix}\frac{V ( x , y )}{0.5 π {s}^{2}} < 0 {\vert}_{u \geq 0} \\ \frac{V ( x , y )}{0.5 π {s}^{2}} \geq 0 {\vert}_{u < 0}\end{matrix} .$$

14. The computer-implemented method recited in claim 13, further comprising:
receiving a secondary Gaussian density corresponding to the portion of the simulated resist pattern; and
wherein the transport kernel is based in part upon a shifted convolution of the secondary Gaussian density derivation.

15. The computer-implemented method recited in claim 11, the visibility density component being an internal visibility density component.

16. The computer-implemented method recited in claim 15, wherein:
the portion of the simulated resist pattern is partitioned into a grid having coordinates x and y;
the portion of the simulated resist pattern has a polygon V;
the etchant has a diffusion length s;
the internal visibility density component D for a given edge offset u is derived from the following equation:
$$D ( s , u ; x , y ) = \{ \begin{matrix}\frac{V ( x , y )}{0.5 π {s}^{2}} \geq 0 {\vert}_{u \geq 0} \\ \frac{V ( x , y )}{0.5 π {s}^{2}} < 0 {\vert}_{u < 0}\end{matrix} .$$

17. One or more tangible computer-readable media, having computer executable instructions for calibrating a mask process model stored thereon, the computer executable instructions comprise:
causing a computer to perform a set of operations; and
wherein the set of operations include:
receiving at least a portion of a simulated resist pattern;
identifying an etch function that approximates an optical lithographic etching process by relating a simulated resist image to a simulated etched image, the etch function having a transport kernel and a visibility kernel; and
deriving on the computer a simulated etched pattern by solving the etch function for the portion of the simulated resist pattern.

18. The one or more tangible computer-readable media recited in claim 17, the set of operations further comprising saving the simulated etched pattern onto one or more tangible memory storage media.

19. The one or more tangible computer-readable media recited in claim 18, the visibility kernel comprising a visibility density component.

20. The one or more tangible computer-readable media recited in claim 19, the visibility density component being a direct visibility density component.

21. The one or more tangible computer-readable media recited in claim 20, wherein:
the portion of the simulated resist pattern is partitioned into a grid having coordinates x and y;
the portion of the simulated resist pattern has a polygon V;
the etchant has a diffusion length s;
the direct visibility density component D for a given edge offset u is derived from the following equation:
$$D ( s , u ; x , y ) = \{ \begin{matrix}\frac{V ( x , y )}{0.5 π {s}^{2}} < 0 {\vert}_{u \geq 0} \\ \frac{V ( x , y )}{0.5 π {s}^{2}} \geq 0 {\vert}_{u < 0}\end{matrix} .$$

22. The one or more tangible computer-readable media recited in claim 21, further comprising:
receiving a secondary Gaussian density corresponding to the portion of the simulated resist pattern; and
wherein the transport kernel is based in part upon a shifted convolution of the secondary Gaussian density derivation.

23. The one or more tangible computer-readable media recited in claim 20, the visibility density component being an internal visibility density component.

24. The one or more tangible computer-readable media recited in claim 23, wherein:
the portion of the simulated resist pattern is partitioned into a grid having coordinates x and y;
the portion of the simulated resist pattern has a polygon V;
the etchant has a diffusion length s;
the internal visibility density component D for a given edge offset u is derived from the following equation:
$$D ( s , u ; x , y ) = \{ \begin{matrix}\frac{V ( x , y )}{0.5 π {s}^{2}} \geq 0 {\vert}_{u \geq 0} \\ \frac{V ( x , y )}{0.5 π {s}^{2}} < 0 {\vert}_{u < 0}\end{matrix} .$$
